(19) United States
(12) Patent Application Publication
(10) Pub. No.: US 2010/0141111 A1
(43) Pub. Date: Jun. 10, 2010

(54) COMPOSITION FOR INTEGRATED CATHODE-ELECTRON EMISSION SOURCE, METHOD OF FABRICATING INTEGRATED CATHODE-ELECTRON EMISSION SOURCE, AND ELECTRON EMISSION DEVICE USING THE SAME

(76) Inventors: So-Ra Lee, Suwon-si (KR); Jae-Myung Kim, Suwon-si (KR); Yoon-Jin Kim, Anyang-si (KR); Kyu-Nam Joo, Suwon-si (KR); Jae-Sun Jeong, Lausanne (CH)

Correspondence Address: CHRISTIE, PARKER & HALE, LLP, PO BOX 7068, PASADENA, CA, 91109-7068, US

(21) Appl. No.: 12/631,753

(22) Filed: Dec. 4, 2009

(30) Foreign Application Priority Data
Dec. 9, 2008 (KR) 10-2008-0124890

(51) Int. Cl. H01J 1/30; H01B 1/22

(52) U.S. Cl. 313/310; 252/503; 977/939

(57) ABSTRACT

A composition for an integrated cathode-electron emission source includes (A) 0.5 to 60 wt % of a metal powder, (B) 0.1 to 10 wt % of a carbon-based material, (C) 1 to 40 wt % of an inorganic filler, and (D) 5 to 95 wt % of a vehicle. A method of making an integrated cathode-electron emission source includes coating the composition on a substrate, and heat treating the coated substrate. An electron emission device includes a first substrate and a second substrate facing each other, an integrated cathode-electron emission source including a metal and a carbon-based electron emission source on one surface of the first substrate, and a light emitting unit on one surface of the second substrate.

### CROSS-REFERENCE TO RELATED APPLICATION

This application claims priority to and the benefit of Korean Patent Application No. 10-2008-0124890 filed in the Korean Intellectual Property Office on Dec. 9, 2008, the entire content of which is incorporated herein by reference.

### BACKGROUND OF THE INVENTION

1. Field of the Invention

This disclosure relates to a composition for an integrated cathode-electron emission source, a method for fabricating an integrated cathode-electron emission source, and an electron emission device using the composition.

2. Description of the Related Art

Early field emission display (FED) type electron emission devices were made using Spindt-type electron emission sources in which layers laminated with a material of Mo or Si, etc., were processed to have sharp tips. However, since the Spindt-type electron emission source has an ultra-fine structure and the manufacturing method is very complicated, a high degree of precision work is required. Consequently, it is too difficult to manufacture large-sized field emission display devices using this method.

Therefore, carbon-based materials have recently been used as electron emission sources due to their low work function. In particular, carbon nanotubes (CNT) are expected to be good electron emission sources since they have a high aspect ratio and a small tip radius with a curvature of 100 Å, thereby readily emitting electrons by an external voltage of as low as 1-3V/μm. Carbon nanotubes make it possible to drive the electron emission source at a low temperature and to easily fabricate the electron emission source due to the low work function characteristic, making them appropriate for realizing large area displays.

Generally, an electrode (e.g., a cathode) of an electron emission device is fabricated in two processes, namely, fabrication of the electron emission source (e.g., by preparing a carbon nanotube paste), and fabrication of the electrode. This two process fabrication method requires controlled baking conditions or frit to be added to the carbon nanotube paste for adhesion between the electrode and the electron emission source.

Also, although screen printing is generally used, screen printing methods have the disadvantage of hardly printing in the inner part of a curved substrate. Jetting or dispensing printing methods have been used, but when there is a difference between the electrode printing method and the electron emission source printing method, production costs increase considerably.

### SUMMARY OF THE INVENTION

In one embodiment of the present invention, a composition for forming an integrated cathode-electron emission source decreases production cost, eases repeated operations, and provides high resolution.

In another embodiment of the present invention, a method for fabricating an integrated cathode-electron emission source integrates the fabrication of a cathode and the fabrication of an electron emission source, such that both are performed simultaneously in one process by using the composition.

In yet another embodiment of the present invention, an electron emission device is fabricated using the composition for fabricating an integrated cathode-electron emission source.

According to one embodiment of the present invention, a composition for an integrated cathode-electron emission source includes: (A) about 0.5 to about 60 wt % of a metal powder, (B) about 0.1 to about 10 wt % of a carbon-based material, (C) about 1 to about 40 wt % of an inorganic filler, and (D) about 5 to about 95 wt % of a vehicle.

According to another embodiment of the present invention, a method for fabricating an integrated cathode-electron emission source includes: coating a substrate with a composition including a metal powder, a carbon-based material, an inorganic filler, and a vehicle; and heat treating the substrate coated with the composition.

According to another embodiment of the present invention, an electron emission device includes: a vacuum container including a first substrate and a second substrate arranged opposite to each other, and a sealing member disposed between the first substrate and the second substrate; an integrated cathode-electron emission source on one surface of the first substrate; and a light emitting unit on one surface of the second substrate, wherein the integrated cathode-electron emission source includes a metal and carbon-based electron emission source.

The metal powder (A) may include a metal selected from Sn, Sn alloys, Ag, Ag alloys, Au, Au alloys, Ti, Ti alloys, Zn, Zn alloys, Mo, Mo alloys, In, In alloys, Pt, Pt alloys, and combinations thereof.

The carbon-based material (B) may include a material selected from carbon nanotubes, graphite, graphite nanofiber, diamond, diamond-like carbon, fullerene, and combinations thereof. In one embodiment, for example, the carbon-based material (B) may be carbon nanotubes.

The inorganic filler (C) may include an oxide powder or glass frit selected from SiO₂, Al₂O₃, BaTiO₃, (Ba,Sr)TiO₃ (where (Ba,Sr) denotes that both Ba and Sr are present in the oxide), SrTiO₂, InSn₂O₃, and combinations thereof.

The vehicle (D) may include a material selected from resins, solvents and combinations thereof. Nonlimiting examples of suitable resins include cellulose-based resins, acryl-based resins, vinyl-based resins, and combinations thereof. Nonlimiting examples of suitable solvents include terpineol, butyl carbitol, butyl carbitol acetate, toluene, texanol, and combinations thereof.

The substrate may be coated with the composition by screen printing, and the heat treatment may be performed at a temperature of about 300 to about 500° C.

### BRIEF DESCRIPTION OF THE DRAWINGS

FIG. 1A is a cross-sectional view of a composition before heat treatment in accordance with an embodiment of the invention.

FIG. 1B is a cross-sectional view of a composition after heat treatment in accordance with an embodiment of the invention.

FIG. 2 is a partial exploded perspective view of an electron emission device in accordance with an embodiment of the invention.

FIG. 3 is a scanning electron microscope (SEM) picture of an integrated cathode-electron emission source fabricated according to the Example.

FIG. 4 is a graph comparing the current density of the integrated cathode-electron emission source fabricated according to the Example to the electron emission source fabricated according to the Comparative Example.

### DETAILED DESCRIPTION OF THE INVENTION

Exemplary embodiments will hereinafter be described in detail. However, these embodiments are only exemplary, and the present invention is not limited thereto.

A composition for an integrated cathode-electron emission source according to one embodiment of the present invention includes: (A) a metal powder, (B) a carbon-based material, (C) an inorganic filler, and (D) a vehicle.

The metal powder (A) may be an inorganic metal powder or an elemental metal powder, and may include a metal having a melting point of about 500° C. or less.

Nonlimiting examples of suitable metals for the metal powder include Sn, Sn alloys, Ag, Ag alloys, Au, Au alloys, Ti, Ti alloys, Zn, Zn alloys, Mo, Mo alloys, In, In alloys, Pt, Pt alloys, and combinations thereof. In one embodiment, for example, the metal is selected from Sn, Ti, and combinations thereof.

The metal powder may be included in an amount of about 0.5 to about 60 wt % based on the total weight of the composition for an integrated cathode-electron emission source. In one embodiment, for example, the metal powder is included in an amount of about 20 to about 40 wt % based on the composition for an integrated cathode-electron emission source. When the metal powder is included in an amount that falls in this range, it may provide sufficient conductivity and optimize the density of the emission tips.

Nonlimiting examples of suitable carbon-based materials include carbon nanotubes, graphite, graphite nanofiber, diamond, diamond-like carbon, fullerene, and combinations thereof. In one embodiment, for example, the carbon-based material is carbon nanotubes.

The carbon nanotubes may be any kind of carbon nanotubes, including single-walled (SW), double-walled (DW), or multi-walled (MW) carbon nanotubes, and can include a combination of different kinds of carbon nanotubes.

The carbon-based material may be included in an amount of about 0.1 to about 10 wt % based on the total weight of the composition for an integrated cathode-electron emission source. In one embodiment, for example, the carbon-based material is included in an amount of about 0.1 to about 5 wt % based on the total weight of the composition for an integrated cathode-electron emission source. When the amount of the carbon-based material falls in this range, the emission current density may be optimized.

The inorganic filler (C) may include an oxide powder or glass frit, nonlimiting examples of which include SiO₂, Al₂O₃, BaTiO₃, (Ba,Sr)TiO₃ (where (Ba,Sr) denotes that both Ba and Sr are present in the oxide), SrTiO₂, InSn₂O₃, and combinations thereof.

The inorganic filler may be included in an amount of about 1 to about 40 wt %, and in one embodiment in an amount of about 10 to about 20 wt % based on the total weight of the composition for an integrated cathode-electron emission source. When the amount of the inorganic filler falls in this range, the carbon nanotubes may be optimally dispersed.

The vehicle (D) may include a material selected from resins, solvents, and combinations thereof.

Nonlimiting examples of suitable resins for use as the vehicle include cellulose-based resins (such as ethyl cellulose, nitro cellulose, and the like), acryl-based resins (such as polyester acrylate, epoxy acrylate, urethane acrylate, and the like), vinyl-based resins (such as polyvinyl acetate, polyvinyl butyral, polyvinyl ether, and the like), and combinations thereof.

Nonlimiting examples of suitable solvents for use as the vehicle include terpineol, butyl carbitol (BC), butyl carbitol acetate (BCA), toluene, texanol, and combinations thereof.

The vehicle may be included in an amount of about 5 to about 95 wt % based on the total weight of the composition for an integrated cathode-electron emission source. In one embodiment, for example, the vehicle is included in an amount of about 60 to about 80 wt % based on the total weight of the composition for an integrated cathode-electron emission source. When the amount of the vehicle falls in this range, viscosity appropriate for screen printing may be acquired.

The composition according to some embodiments may be prepared by mixing the metal powder, the carbon-based material, the inorganic filler, and the vehicle for controlling the viscosity and optimally dispersing the mixture by a mechanical dispersing method, such as, for example, by using a 3-roll miller, a homogenizer, or an impeller.

According to another embodiment, an electrode for an electron emission device and an electron emission source may be fabricated through one process by using the composition including the above-mentioned ingredients. In one embodiment, for example, a method for fabricating an integrated cathode-electron emission source includes coating a substrate with a composition including a metal powder, a carbon-based material, an inorganic filler, and a vehicle, and heat treating the substrate coated with the composition.

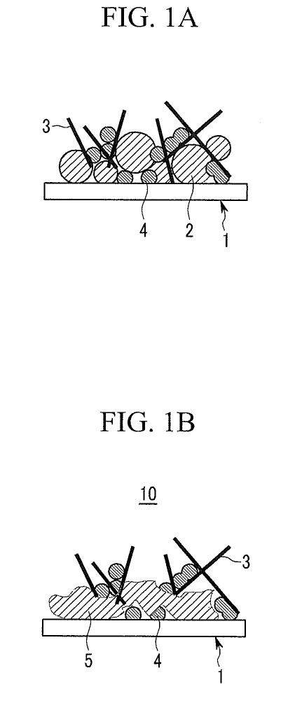

Fabrication of an electron emission source has typically been performed through two processes. An electrode is formed first, and the electrode is then thickly coated with a composition including a carbon-based material. The substrate coated with the composition undergoes heat treatment to thereby form an electron emission source. According to embodiments of the present invention, however, a method fabricates an electrode and an electron emission source through one process by using a composition including a metal powder and a carbon-based material. The fabrication method will now be described in further detail with reference to FIGS. 1A and 1B.

FIG. 1A illustrates a composition before heat treatment in accordance with an embodiment, and FIG. 1B illustrates a composition after heat treatment in accordance with an embodiment. Referring to FIGS. 1A and 1B, a substrate 1 may be coated with a composition including a metal powder 2, a carbon-based material 3, an inorganic filler 4, and a vehicle. When heat treatment is performed on the substrate 1 coated with the composition, the metal powder 2 may melt and/or coagulate to thereby fix the inorganic filler 4. Accordingly, the carbon-based material 3 existing between the particles of the inorganic filler 4 may also be fixed. The molten metal powder 5 may naturally form an electrode, and at the same time, may also form an electron emission source. As a result, as shown in FIG. 1B, an integrated cathode-electron emission source 10 according to an embodiment of the present invention may be formed.

Since an electrode and an electron emission source do not have to be formed separately in embodiments of the present invention, an additional process for adhesion between the two is not required.

According to one embodiment, the composition may be applied to the substrate using a screen printing method. Also, the heat treatment may be performed at a temperature of about 300 to about 500° C.

In another embodiment, an electron emission device is fabricated using the composition.

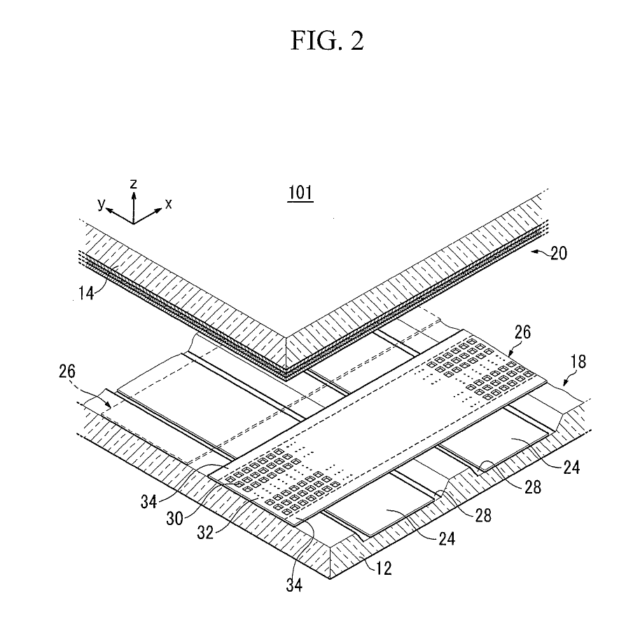

FIG. 2 is a partially exploded perspective view of an electron emission device according to an embodiment. Referring to FIG. 2, an electron emission device 101 according to one embodiment includes a first substrate 12 and a second substrate 14 arranged opposite to each other, and a sealing member between the first substrate 12 and the second substrate 14 and laminating the first and second substrates 12 and 14 to each other to form a vacuum container. The inside of the vacuum container maintains a vacuum degree of approximately 10⁻⁶ Torr.

A region inside the sealing member between the first substrate 12 and the second substrate 14 may include a light emitting region for emitting visible light and a non-light emitting region surrounding the light emitting region. An electron emission unit 18 for emitting electrons may be disposed in the light emitting region of the inner surface of the first substrate 12, and a light emitting unit 20 for emitting visible light may be disposed in the light emission region of the inner surface of the second substrate 14.

The second substrate 14, where the light emitting unit 20 is disposed, may be a front substrate of the electron emission device 101.

In one embodiment, the electron emission unit 18 may include an integrated cathode-electron emission source 24 where the electron emission source and the cathode are simultaneously formed. As used herein, “integrated” signifies that the cathode and the electron emission source are not formed in different layers but are formed in a single layer. The integrated cathode-electron emission source 24 may be fabricated using a composition prepared according to the previously-described embodiments, and thus the integrated cathode-electron emission source 24 may include a metal and carbon-based electron emission source. Also, the electron emission unit 18 may further include a gate electrode 26 formed on the first substrate 12.

In one embodiment, the integrated cathode-electron emission source 24 may be formed in a stripe pattern in a y direction (i.e., y-axis direction marked in FIG. 2) of the first substrate 12, and the gate electrode 26 may be formed over the integrated cathode-electron emission source 24 in a stripe pattern in an x direction (i.e., x-axis direction marked in FIG. 2) generally perpendicular to the y direction of the integrated cathode-electron emission source 24.

In one embodiment, a recessed portion 28 may be formed to a predetermined depth in the inner surface of the first substrate 12 facing the second substrate 14, and the integrated cathode-electron emission source 24 may be disposed in the recessed portion 28. The recessed portion 28 may be formed by removing part of the first substrate 12 through etching or sand blasting. The recessed portion 28 may be formed in a stripe pattern along a longitudinal direction of the integrated cathode-electron emission source 24.

The recessed portion 28 may be formed to a width that is greater than the width of the integrated cathode-electron emission source 24, and may be formed to a depth that is greater than the thickness of the integrated cathode-electron emission source 24. The recessed portion 28 may have a vertical sidewall or a slanted sidewall.

The gate electrode 26 may be formed of a metal plate having a thickness that is greater than the thickness of the integrated cathode-electron emission source 24, and may include a mesh 32 having openings 30 for passing electron beams therethrough, and a supporting member 34 surrounding the mesh 32. For example, the gate electrode 26 may be formed by cutting a metal plate into strips, and removing part of the metal plate through, e.g., etching to thereby form the openings 30.

The gate electrode 26 may be formed of nickel-iron alloy or any other suitable metal or metal alloy to a thickness of approximately 50 μm and a width of approximately 10 mm.

The gate electrode 26 may be fabricated through a separate process from the process of forming the integrated cathode-electron emission source 24, and may be fixed on top of the first substrate 12 in a direction generally perpendicular to the integrated cathode-electron emission source 24. As the integrated cathode-electron emission source 24 is disposed in the recessed portion 28 of the first substrate 12, affixing the gate electrode 26 on top of the first substrate 12 may automatically insulate the gate electrode 26 from the integrated cathode-electron emission source 24.

Also, the mesh 32 of the gate electrode 26 may be formed not only in the part corresponding to the position of the integrated cathode-electron emission source 24, but also in the part not corresponding to the position of the integrated cathode-electron emission source 24. For example, one gate electrode 26 may include one mesh 32. In this case, the arrangement of the gate electrode 26 on the first substrate 12 need not be considered.

The gate electrodes 26 may be fixed on the first substrate 12 using the sealing member, without the need for an additional fixing member.

As described above, when a composition of embodiments of the present invention is used, it is possible to form an electron emission device and an electron emission source in one process. This decreases production costs and reduces the repetition of processes, while producing an electrode with high resolution.

The following examples are presented for illustrative purposes only, and do not limit the scope of the present invention.

### EXAMPLES

### Example

A metal powder was prepared by mixing 96.7 wt % of Sn, 3 wt % of Ag, and 0.3 wt % of Cu. A paste composition was prepared by mixing the prepared metal powder and 10 g of a mixture of carbon nanotubes, inorganic filler and vehicle at a weight ratio of carbon nanotubes:inorganic filler:vehicle of 0.1:2:7.9. The carbon nanotubes used were obtained from Carbon Nanotechnologies Inc. (CNI) and had thin multiple walls, and the inorganic filler was a Bi-based non-lead frit. The vehicle was an acryl-based resin.

Then, the prepared paste composition was applied to a glass substrate through screen printing, and heat treatment was performed at 490° C. to thereby form an integrated cathode-electron emission source.

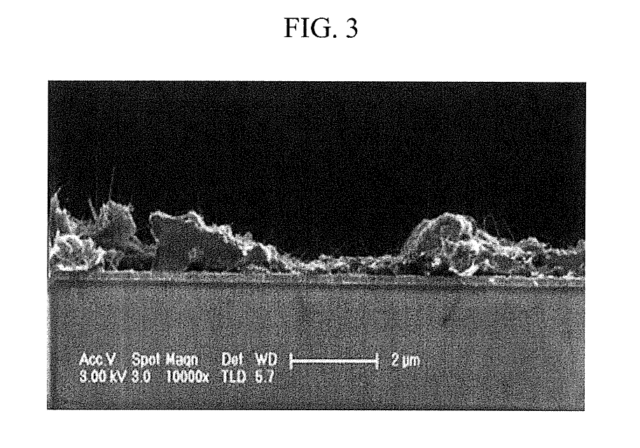

FIG. 3 is a scanning electron microscope (SEM) picture of the fabricated integrated cathode-electron emission source.

### Comparative Example

A paste composition was prepared by mixing carbon nanotubes, inorganic filler and a vehicle at a weight ratio of carbon nanotubes:inorganic filler:vehicle of 0.1:2:7.9.

The prepared paste composition was applied to a cathode by screen printing, and heat treatment was performed at 490° C. to thereby form an electron emission source.

### Measurement of Conductivity

The conductivity of the integrated cathode-electron emission source fabricated according to the Example and the conductivity of the electron emission source fabricated according to the Comparative Example were measured using a multi-tester after tape activation.

The measurement results showed that the integrated cathode-electron emission source fabricated according to the Example had a conductivity of 79 ohms and the electron emission source fabricated according to the Comparative Example had a conductivity of 70 to 80 ohms. It may be seen from these results that the integrated cathode-electron emission source has sufficient conductivity even though the cathode and electron emission source were formed simultaneously.

### Measurement of Current Density

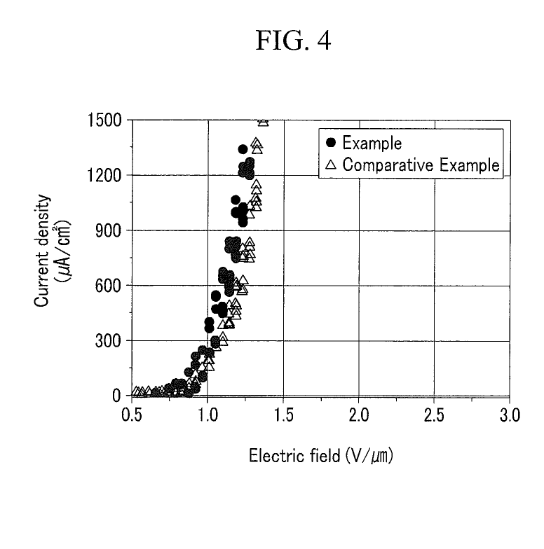

FIG. 4 is a graph comparing the current density of the integrated cathode-electron emission source fabricated according to the Example to the current density of the electron emission source fabricated according to the Comparative Example. FIG. 4 shows that the integrated cathode-electron emission source fabricated according to the Example had higher current density than that of the electron emission source fabricated according to the Comparative Example in a uniform electric field. It may be seen from FIG. 4 that good conductivity may be acquired even when the cathode and electron emission source are formed simultaneously.

While the present invention has been described in connection with certain exemplary embodiments, it is understood by those of ordinary skill in the art that certain modifications may be made to the described embodiments without departing from the spirit and scope of the present invention, as defined by the appended claims.

What is claimed is:

1. A composition for an integrated cathode-electron emission source, comprising:
(A) about 0.5 to about 60 wt % of a metal powder;
(B) about 0.1 to about 10 wt % of a carbon-based material;
(C) about 1 to about 40 wt % of an inorganic filler; and
(D) about 5 to about 95 wt % of a vehicle.

2. The composition of claim 1, wherein the metal powder (A) comprises a metal selected from the group consisting of Sn, Sn alloys, Ag, Ag alloys, Au, Au alloys, Ti, Ti alloys, Zn, Zn alloys, Mo, Mo alloys, In, In alloys, Pt, Pt alloys, and combinations thereof.

3. The composition of claim 1, wherein the carbon-based material (B) comprises a material selected from the group consisting of carbon nanotubes, graphite, graphite nanofiber, diamond, diamond-like carbon, fullerene, and combinations thereof.

4. The composition of claim 1, wherein the carbon-based material (B) comprises carbon nanotubes.

5. The composition of claim 1, wherein the inorganic filler (C) comprises an oxide powder or glass frit selected from the group consisting of SiO₂, Al₂O₃, BaTiO₃, (Ba,Sr)TiO₃, SrTiO₂, InSn₂O₃, and combinations thereof.

6. The composition of claim 1, wherein the vehicle (D) comprises a material selected from the group consisting of:
resins selected from the group consisting of cellulose-based resins, acryl-based resin, vinyl-based resins, and combinations thereof;
solvents selected from the group consisting of terpineol, butyl carbitol, butyl carbitol acetate, toluene, texanol, and combinations thereof; and
combinations thereof.

7. A method for fabricating an integrated cathode-electron emission source, comprising:
coating a substrate with a composition comprising a metal powder, a carbon-based material, an inorganic filler, and a vehicle; and
heat treating the substrate coated with the composition.

8. The method of claim 7, wherein the metal powder (A) comprises a metal selected from the group consisting of Sn, Sn alloys, Ag, Ag alloys, Au, Au alloys, Ti, Ti alloys, Zn, Zn alloys, Mo, Mo alloys, In, In alloys, Pt, Pt alloys, and combinations thereof.

9. The method of claim 7, wherein the carbon-based material (B) comprises a material selected from the group consisting of carbon nanotubes, graphite, graphite nanofiber, diamond, diamond-like carbon, fullerene, and combinations thereof.

10. The method of claim 7, wherein the carbon-based material (B) comprises carbon nanotubes.

11. The method of claim 7, wherein the inorganic filler (C) comprises an oxide powder or glass frit selected from the group consisting of SiO₂, Al₂O₃, BaTiO₃, (Ba,Sr)TiO₃, SrTiO₂, InSn₂O₃, and combinations thereof.

12. The method of claim 7, wherein the vehicle (D) comprises a material selected from the group consisting of:
resins selected from the group consisting of cellulose-based resins, acryl-based resins, vinyl-based resins, and combinations thereof;
solvents selected from the group consisting of terpineol, butyl carbitol, butyl carbitol acetate, toluene, texanol, and combinations thereof; and
combinations thereof.

13. The method of claim 7, wherein the coating the substrate with the composition comprises screen printing the composition onto the substrate.

14. The method of claim 7, wherein the heat treating is performed at a temperature of about 300 to about 500° C.

15. An electron emission device, comprising:
a first substrate and a second substrate facing each other;
an integrated cathode-electron emission source on one surface of the first substrate; and
a light emitting unit on one surface of the second substrate,
wherein the integrated cathode-electron emission source includes a metal and a carbon-based electron emission source.

16. The electron emission device of claim 15, wherein the metal comprises a metal selected from the group consisting of Sn, Sn alloys, Ag, Ag alloys, Au, Au alloys, Ti, Ti alloys, Zn, Zn alloys, Mo, Mo alloys, In, In alloys, Pt, Pt alloys, and combinations thereof.

17. The electron emission device of claim 15, wherein the carbon-based electron emission source comprises a material selected from the group consisting of carbon nanotubes, graphite, graphite nanofiber, diamond, diamond-like carbon, fullerene, and combinations thereof.

18. The electron emission device of claim 15, wherein the carbon-based electron emission source comprises carbon nanotubes.
